(19) United States
(12) Patent Application Publication
(10) Pub. No.: US 2006/0218793 A1
(43) Pub. Date: Oct. 5, 2006

(54) Electric razor with helical filament winding

(75) Inventor: Shlomo Zucker, Michmoret (IL)

Correspondence Address: DR. MARK FRIEDMAN LTD.;C/o Bill Polkinghorn, 9003 Florin Way, Upper Marlboro, MD, 20772, US

(73) Assignee: WHEEL TECHNOLOGY LTD.

(21) Appl. No.: 11/385,793

(22) Filed: Mar. 22, 2006

(30) Foreign Application Priority Data
Mar. 31, 2005 (IL) 167786

(51) Int. Cl. B26B 19/14; B26B 19/04

(52) U.S. Cl. 30/43.4; 30/346.51

(57) ABSTRACT

A roller assembly for an electric razor includes a generally cylindrical roller driven by a drive arrangement to rotate about a central axis. The roller supports a number of blades, each having a cutting edge externally exposed and extending parallel to the central axis. Each blade moves across the skin of a user so as to slice through hair projecting from the skin of the user. The roller assembly further includes at least one filament wond in a helical path around the roller such that a gap between adjacent portions of the filament along the cutting edges is no more than about 8 millimeters.

### FIELD AND BACKGROUND OF THE INVENTION

The present invention relates to electric razors and, in particular, it concerns an electric razor with one or more exposed-blade rotating roller which employs a filament wound in a helical configuration around the rollers.

This application relates primarily to an electric razor of a type generally similar to that described in co-assigned U.S. Pat. No. 6,442,840 which is hereby incorporated herein in its entirety. In all respects other than those addressed explicitly in this document, the structure and operation of the razor should be understood to be as described in the aforementioned document.

The aforementioned electric razor is unusual in that it crosses the boundaries of the generally accepted criteria which distinguish electric razors from manual razors. Specifically, in most cases, electric razors employ a scissors-like cutting action between moving blades and a thin perforated foil or other stationary skin-contact surface. Manual razors, on the other hand, typically have one or more exposed blade which passes across the skin in direct contact with the skin, and which slices through the hairs without the aid of any opposing edge. The aforementioned US patent, on the other hand, provides an electrically driven exposed-blade roller with a plurality of blades which act as exposed blades passing across the skin in direct contact with the skin and cutting hair without the aid of any opposing edge. The present invention provides various improvements to an implementation of this unusual type of electric razor.

In the field of manual razors, it is known to employ metal wires stretched across the blades in the direction of travel, i.e., perpendicular to the cutting edges of the blades, to provide safety blade protection. Examples of such razors, referred to as “wire-wrapped blades”, are commercially available from SCHICK®. Since the wire wrapping around the blades is aligned with the direction of travel of the blades, it tends to cause a “shadow”, i.e., leaves tracks along the paths traveled by the wires where the blades did not have access to the hairs. Furthermore, the wires do not contribute to the lifting of hairs during the shaving process.

There is therefore a need for an electric razor of the electrically driven exposed-blade roller type which would employ a helical filament winding to avoid leaving “shadows” and to enhance raising of hairs during the shaving process.

### SUMMARY OF THE INVENTION

The present invention is an electric razor with exposed-blade rollers wherein the rollers are at least partially wound with a filament in a helical configuration.

According to the teachings of the present invention there is provided, a roller assembly for an electric razor comprising: (a) a substantially cylindrical roller rotatably mounted so as to be rotatable about a central axis, the roller supporting a plurality of blades, each blade deployed with a cutting edge externally exposed and extending parallel to the central axis, each blade being deployed for moving across the skin of a user so as to slice through hair projecting from the skin of the user; and (b) a drive arrangement for driving the roller so as to rotate about the central axis, characterized in that the roller assembly further comprises at least one filament wound in a helical path around the roller such that a gap between adjacent portions of the at least one filament as measured along the cutting edge for each blade is no more than about 8 millimeters.

According to a further feature of the present invention, the at least one filament is wound around the roller such that a gap between adjacent portions of the at least one filament as measured along the cutting edge for each blade is no more than about 5 millimeters.

According to a further feature of the present invention, the at least one filament is wound around the roller such that a gap between adjacent portions of the at least one filament as measured along the cutting edge for each blade is at least about 2 millimeters.

According to a further feature of the present invention, the at least one filament is a single filament wound in a single helix around the roller. According to an alternative feature of the present invention, the at least one filament is wound in double helix around the roller.

According to a further feature of the present invention, a first part of the helical path is a right-handed helical path and a second part of the helical path is a left-handed helical path.

According to a further feature of the present invention, a pitch of the helical path is between 1 degree and 30 degrees, and preferably less than 10 degrees.

According to a further feature of the present invention, the roller includes a plurality of convexly curved blade cartridges each carrying a plurality of the blades, and most preferably three of the blades.

According to a further feature of the present invention, each of the blade cartridges is formed with at least one lateral anchoring surface extending around a majority of a dimension of the cartridge perpendicular to the length of the blades to provide contact surfaces for attachment of ends of the filament.

According to a further feature of the present invention, the filament has a thickness of between 0.07 millimeters and 0.5 millimeters, and preferably of less than 0.2 millimeters.

According to a further feature of the present invention, the filament is a round filament. According to an alternative feature of the present invention, the filament is a semicircular filament.

According to a further feature of the present invention, an outer surface of the roller is formed with an array of alignment features deployed along a length of the roller parallel to the cutting edges, the alignment features being configured to engage windings of the filament so as to prevent migration of the filament along the roller.

### BRIEF DESCRIPTION OF THE DRAWINGS

The invention is herein described, by way of example only, with reference to the accompanying drawings, wherein:

FIGS. 1A, 1B, 1C and 1D are isometric, top, longitudinal cross-sectional and transverse cross-sectional views, respectively, of a roller assembly, constructed and operative according to the teachings of the present invention, from the electric razor of the present invention;

FIG. 2 is a schematic side view illustrating the effect of a helical filament winding of the roller assembly of FIGS. 1A-1D;

FIG. 3 is an enlarged view of the roller assembly of FIGS. 1A-1D in contact with the skin illustrating a suggested mechanism of a hair-lifting effect of the roller assembly;

FIGS. 4A, 4B and 4C are isometric view, respectively, of a blade cartridge, a combination of the blade cartridge with a wound filament, and of the assembled roller, respectively, from the roller assembly of FIGS. 1A-1D;

FIG. 5 is an isometric view illustrating a preferred implementation of a drive arrangement for the roller assembly of FIGS. 1A-1D;

FIG. 6 is a side view illustrating a preferred implementation of a release mechanism for allowing replacement of a roller assembly of FIGS. 1A-1D; and

FIG. 7 is an isometric view of an electric razor according to the teachings of the present invention employing the roller assembly of FIGS. 1A-1D.

### DESCRIPTION OF THE PREFERRED EMBODIMENTS

The present invention is an electric razor with exposed-blade rollers wherein the rollers are at least partially wound with a filament in a helical configuration.

The principles and operation of razors according to the present invention may be better understood with reference to the drawings and the accompanying description.

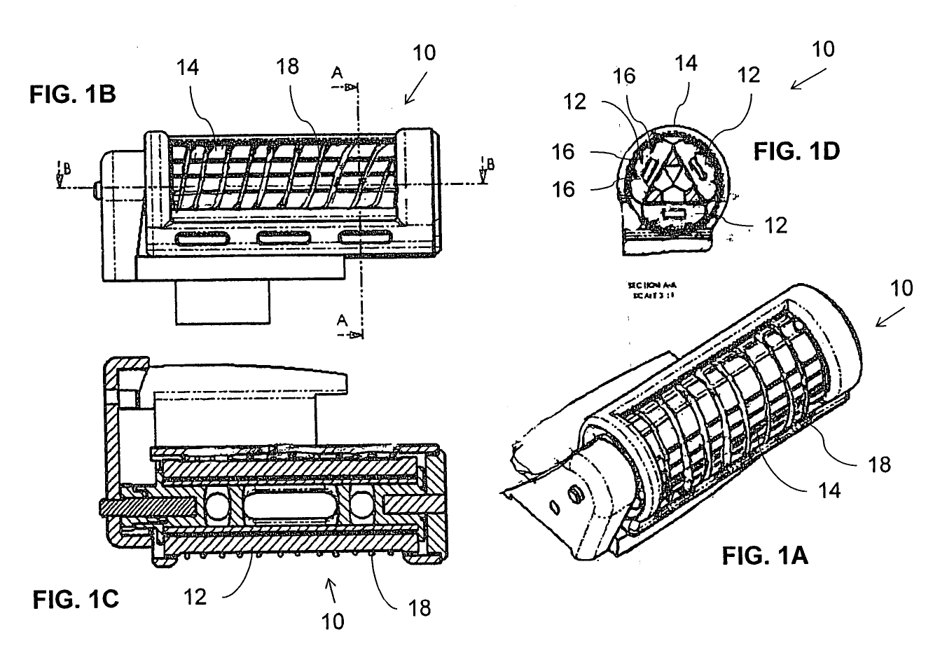

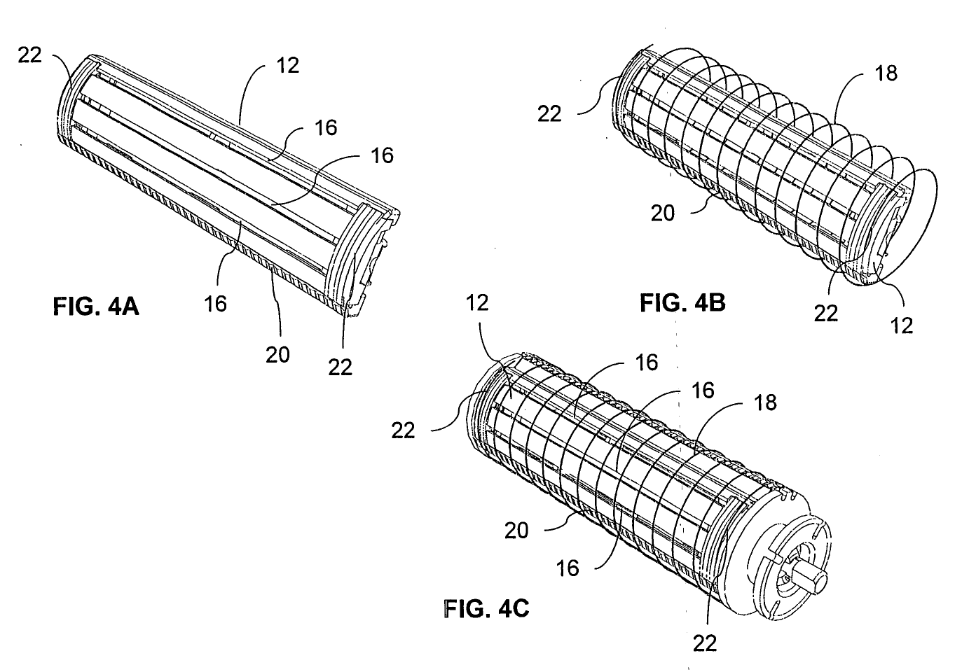

Referring now to the drawings, FIGS. 1A-1D show a particularly preferred option for implementing the one or more roller assemblies, generally designated 10, constructed and operative according to the teachings of the present invention. A particularly effective and cost efficient implementation employs a plurality of convexly curved multi-blade cartridges 12 mounted together to form a blade roller structure 14 approximating to a cylindrical overall form. Preferably, the convexly curved multi-blade cartridges 12 are implemented according to the teachings of one or both of U.S. Pat. Nos. 6,055,731 and 6,305,084, both of which are co-assigned with the present application and which are hereby incorporated by reference in their entirety. As best seen in FIGS. 1D and 4A-4C, the preferred implementation shown here employs three convexly curved blade cartridges 12, each carrying three spaced and differently angled blades 16, to give a total of 9 blades spaced around the circumference of the roller. The cutting edges of the blades 16 are all preferably parallel to each other and to the axis of rotation of roller 14. Clearly, other implementations using blades directly mounted to a roller, or using different numbers of cartridges, also fall within the broad scope of the present invention. The diameter of each roller 14 is preferably between 6 mm and 2 cm, an most preferably between about 12 millimeters and about 16 millimeters.

It is a particularly preferred feature of the present invention that the roller or rollers 14 are provided with a filament 18 wound in a helical formation around at least part, and preferably the entirety, of the length of blades 16. The filament 18 is preferably formed from a metallic (metal or metal alloy) material, and preferably has a thickness of between 0.07 and 0.5 mm, and more preferably between 0.1 and 0.2 mm. One particularly preferred material for the filament 18 is stainless steel. The helical winding may be implemented as a single helix or as a double or other multiple helix using multiple separate wires or a single wire folded. Optionally, the direction (sense) of the helix may reverse one or more times along the length of the roller, for example providing a right-handed helix for one half of the roller and a left-handed helix for the other half.

Before addressing the features of the invention in more detail, it will be useful to define certain terminology as used herein in the description and claims. Firstly, as mentioned above, the present invention belongs to a class of electric razors which employs an exposed-blade cutting action of the type more commonly associated with manual razors. In other words, unlike the scissors-type cutting action of relative motion between two cutting members used by most electric razors, the razor of the present invention employs exposed blades passing across the skin, typically in direct contact with the skin, which slice through the hairs projecting from the skin without closing against any opposing edge or cutting member. The word “slicing” (and its related verb forms) is used herein to identify this unaided cutting action of each blade, in contradistinction to “shearing” which is used to refer to a blade shearing against an opposing edge characteristic of a “scissors-type” cutting action.

The pitch of the helix, defined as the angle of inclination of the wire 18 at any point to a plane perpendicular to the axis of the roller 14, is preferably in the range between 1° and 30°, more preferably between 3° and 15°, and most preferably between 3° and 10°. The larger angles are primarily relevant in the case of a multiple helix. The helical step, i.e., the gap between adjacent windings measured parallel to the length of the blades, is preferably between 2 and 8 mm, and most preferably between 2 and 5 mm.

According to a preferred option best seen in FIGS. 4A-4C, the external surface of roller 14 has a series of alignment features 20, which may be undulations, recesses formed between ridges or a series of V-shaped notches as shown, deployed along the length of the roller parallel to the cutting edges of the blades 16, in order to engage the windings of filament 18 and prevent migration of the filament along the roller 14. In the preferred case of a roller formed from three cartridges 12, each cartridge preferably has a series of alignment features 20 at a spacing of a third of the helical step. This ensures that one of the alignment features of each cartridge is correctly positioned to engage a corresponding portion of the filament 18. In the preferred example illustrated here, each cartridge 12 also features one or more lateral anchoring surface 22 at one or both ends of the cartridge and extending around a majority of the part of the periphery of the roller provided by the cartridge, or a majority of the dimension of the cartridge perpendicular to the length of the blades. Lateral anchoring surfaces 22 provide contact surfaces for the ends of filament 18 which may be anchored thereto by use of adhesive.

Production of the roller blade assembly with the wound filament may be performed by a wide range of techniques including winding techniques in which an elastically or inelastically deformable filament is wound around the assembled cylinder and fastened at its ends. Such techniques are well developed in the field of electronic component manufacture. In alternative techniques, an elastic filament may be preformed to the required helical form so as to tend to deploy itself elastically around the roller. In one particularly advantageous variant of this approach, a wire formed from shape memory alloy such as Nitinol may be preformed into the helical form and then temporarily deformed into a straightened form in which it is stable under controlled temperature conditions. The wire is then triggered by a thermal transition to return to its predefined helical form, thus wrapping itself around the roller to form the required structure.

The filament may have any desired cross-sectional shape, but is most referably either round or approximately semi-circular in cross-section (with the flat side against the roller) to ensure that rounded surfaces of the filament come in contact with the user's skin. Most preferably, a round cross-section is preferred.

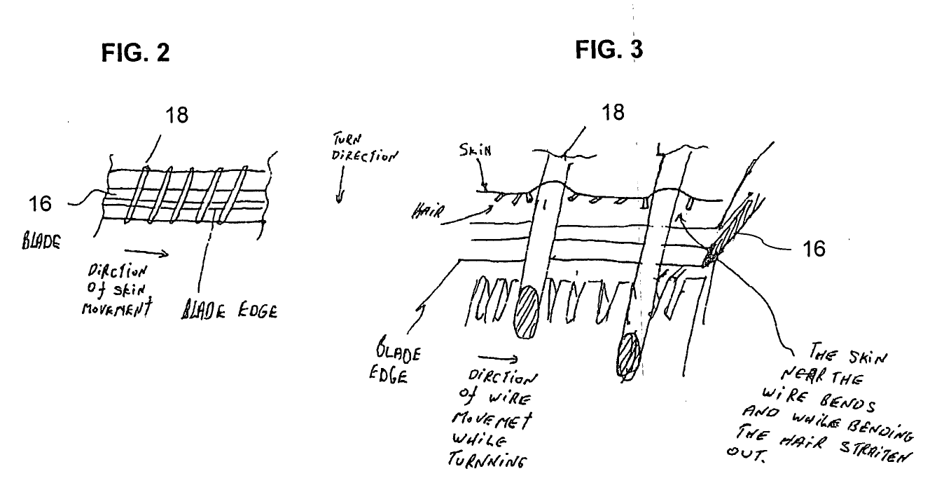

FIGS. 2 and 3 illustrate certain advantages of the helical filament configuration of the present invention. It will be appreciated that the rotation of the helical filament with the roller causes the coils of the filament to appear to travel laterally across the skin surface. This effective shifting of the filament ensures that no single area of the skin remains occluded from the blades, thereby providing uniform shaving over the entire contact area. Furthermore, the filament causes a ripple-like localized deformation of the user's skin as shown in FIG. 3, thereby locally stretching the skin surface so as to raise the hairs. Here too, the deformation of the skin moves dynamically along the length of the roller due to effect of the helix, thereby effectively lifting hairs along the entire length of the roller.

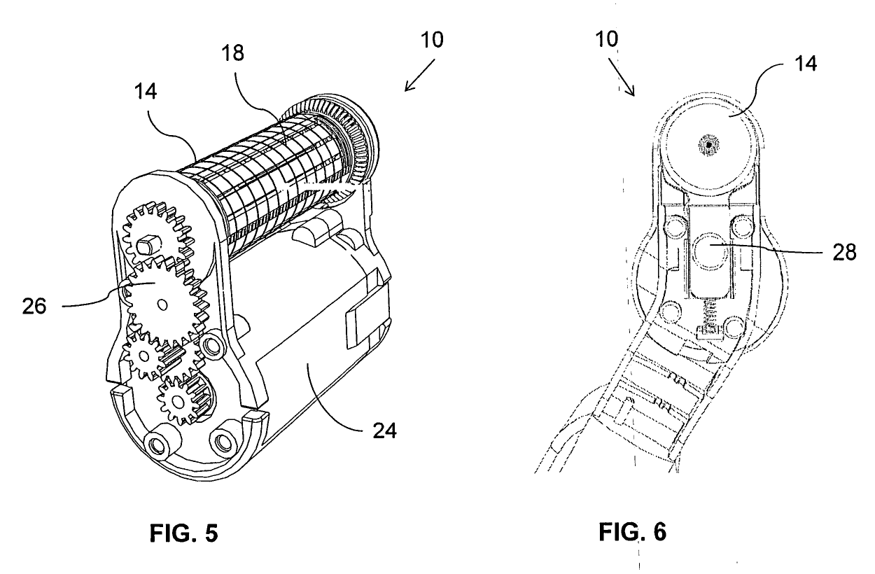

Turning briefly to FIG. 5, this illustrates a preferred implementation of a drive arrangement for driving roller assembly 10. An electric motor is deployed in a motor casing 24 so as to drive roller 14 via a gear train 26.

Turning now to FIG. 6, this shows schematically a release mechanism for allowing replacement of a roller 14 of the electric razor of the present invention. Specifically, downward pressure on a button 28 disengages a spring-biased retainer which retains the end of roller 14 further from gear train 26. This allows removal and replacement of the roller by the user, for example, when the blades become worn.

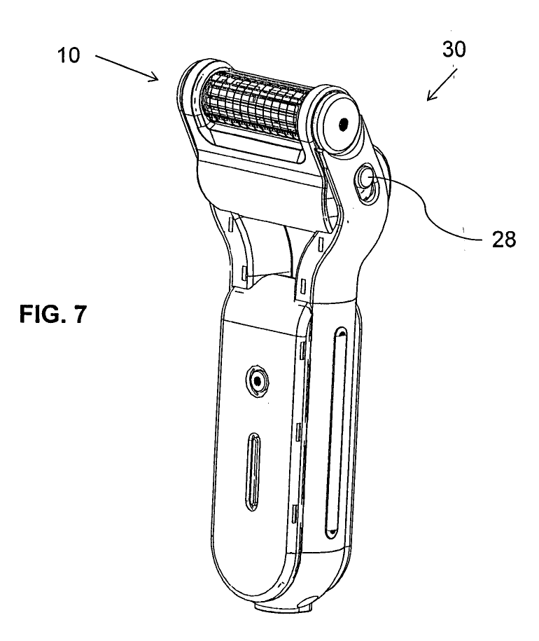

Finally, FIG. 7 shows a general view of an electric razor, generally designated 30, constructed and operative according to the teachings of the present invention, employing roller assembly 10 of FIGS. 1A-1D. The main part of the body of the razor, not described above, typically accommodates rechargeable or replaceable batteries, as well as an on/off switch.

In all other respect, including but not limited to, the single exposed blade cutting mechanism, the options of paired rollers rotating in opposite directions, the structure and operation of the present invention will be understood by reference to the above-incorporated documents.

It will be appreciated that the above descriptions are intended only to serve as examples, and that many other embodiments are possible within the scope of the present invention as defined in the appended claims.

What is claimed is:

1. A roller assembly for an electric razor comprising:
(a) a substantially cylindrical roller rotatably mounted so as to be rotatable about a central axis, said roller supporting a plurality of blades, each blade deployed with a cutting edge externally exposed and extending parallel to said central axis, each blade being deployed for moving across the skin of a user so as to slice through hair projecting from the skin of the user; and
(b) a drive arrangement for driving said roller so as to rotate about said central axis,
characterized in that the roller assembly further comprises at least one filament wound in a helical path around said roller such that a gap between adjacent portions of said at least one filament as measured along said cutting edge for each blade is no more than about 8 millimeters.

2. The roller assembly of claim 1, wherein said at least one filament is wound around said roller such that a gap between adjacent portions of said at least one filament as measured along said cutting edge for each blade is no more than about 5 millimeters.

3. The roller assembly of claim 1, wherein said at least one filament is wound around said roller such that a gap between adjacent portions of said at least one filament as measured along said cutting edge for each blade is at least about 2 millimeters.

4. The roller assembly of claim 1, wherein said at least one filament is a single filament wound in a single helix around said roller.

5. The roller assembly of claim 1, wherein said at least one filament is wound in double helix around said roller.

6. The roller assembly of claim 1, wherein a first part of said helical path is a right-handed helical path and a second part of said helical path is a left-handed helical path.

7. The roller assembly of claim 1, wherein a pitch of said helical path is between 1 degree and 30 degrees.

8. The roller assembly of claim 1, wherein a pitch of said helical path is less than 10 degrees.

9. The roller assembly of claim 1, wherein said roller includes a plurality of convexly curved blade cartridges each carrying a plurality of said blades.

10. The roller assembly of claim 9, wherein each of said blade cartridges carries three of said blades.

11. The roller assembly of claim 9, wherein each of said blade cartridges is formed with an array of alignment features deployed along a length of said cartridge parallel to said cutting edges, said alignment features being configured to engage windings of said filament so as to prevent migration of said filament along said roller.

12. The roller assembly of claim 9, wherein each of said blade cartridges is formed with at least one lateral anchoring surface extending around a majority of a dimension of said cartridge perpendicular to said length of said blades to provide contact surfaces for attachment of ends of said filament.

13. The roller assembly of claim 1, wherein said filament has a thickness of between 0.07 millimeters and 0.5 millimeters.

14. The roller assembly of claim 1, wherein said filament has a thickness of less than 0.2 millimeters.

15. The roller assembly of claim 1, wherein said filament is a round filament.

16. The roller assembly of claim 1, wherein said filament is a semicircular filament.

17. The roller assembly of claim 1, wherein an outer surface of said roller is formed with an array of alignment features deployed along a length of said roller parallel to said cutting edges, said alignment features being configured to engage windings of said filament so as to prevent migration of said filament along said roller.
